(19) United States
(12) Patent Application Publication
(10) Pub. No.: US 2005/0009198 A1
(43) Pub. Date: Jan. 13, 2005

(54) Luminescence-based sensor assembly

(76) Inventors: Brian MacCraith, Portmarnock (IE); Lubos Polerecky, Dublin (IE)

Correspondence Address: MCDONNELL BOEHNEN HULBERT & BERGHOFF LLP, 300 S. WACKER DRIVE, 32ND FLOOR, CHICAGO, IL, 60606, US

(21) Appl. No.: 10/489,268

(22) PCT Filed: Sep. 11, 2002
(86) PCT No.: PCT/IE02/00133

(30) Foreign Application Priority Data
Sep. 11, 2001 (IE) S2001/0825
Jan. 23, 2002 (IE) S2002/0041
Jul. 3, 2002 (IE) S2002/0553

(51) Int. Cl. G01N 21/64

(52) U.S. Cl. 436/172; 422/58; 422/82.05; 422/82.08

(57) ABSTRACT

A luminescence-based sensor assembly is described. The sensor assembly utilizes the angular propagation of light into a substrate to distinguish between light originating from a luminescent source close to the substrate and that from a source further away from the substrate. Utilizing such a technique, it is possible to employ direct illumination of the sources of luminescence.

The present invention relates to a luminescence-based sensor assembly of the type comprising a superstrate; a substrate mounting an emitting spot, array of spots or a layer transmitting luminescence into the substrate; an excitation source; and a detector for measuring some of the light emitted into and transmitted out of the substrate.

Conventionally, for luminescence-based sensing, luminescence molecules forming a spot, an array of spots, or a layer, are placed on a substrate and a detector is used to detect the luminescence.

A vast number of assays carried out in biotechnology and the pharmaceutical industry use surface-bound molecules such as antibodies, which can specifically bind molecules such as antigens, from a fluid, typically a liquid flowing above. If the captured molecules contain a luminescent (which may be a fluorescent) moiety or can be labelled with one, either directly or via another molecule, they can be excited by light and subsequently the luminescence emerging from these captured molecules can provide a means for detecting the specific surface captured molecules. Within the present specification the molecules that have been captured are considered as forming a first layer, whereas other molecules which have not been bound or captured may be considered as forming a second layer. The space that extends from the surface including the luminescence label defines the first layer. It is normally the molecules forming the first layer that are of interest for detection purposes.

In many of these applications, the luminescence is excited by a so-called evanescent wave, which has the advantage of exciting the luminescence at or near the substrate interface, i.e. the first layer, rather than in the bulk superstrate above the substrate, the second layer. Essentially, it is the molecules bound, or adjacent, to the surface of the substrate which are excited and the luminescent molecules that are further away from the surface are not excited and therefore, their luminescence is not transmitted to the substrate. The evanescent wave may be used to control the distance from the surface at which the materials are excited. Essentially, this is achieved due to the localisation of the electromagnetic field of the evanescent wave in close vicinity to the interface between the superstrate and the substrate. The use of such a waveform ensures that the detected light is restricted in origin to a source close to the substrate interface, which is the preferred region of interest. As the illuminating light does not impinge on other molecules above this region there can be no excitation of those molecules and hence they will not contribute to the detected luminescence.

While evanescent wave excitation is extremely useful and effective, in certain circumstances it is not practical or convenient. Excitation by the evanescent field, which is confined to a small region above the waveguide surface and used to excite fluorescently-labelled surface attached molecules, is not particularly efficient, as only a small fraction of energy of the source of the excitation light is used for the actual excitation. This is predominantly due to the following reasons:
(i) inefficient coupling of the light generated by the excitation source into the guided mode(s), and
(ii) the fraction of the optical power contained in the evanescent field is very small in comparison to the power contained within the guiding layer.

Indeed, it would be preferable to use another, more efficient method of providing the excitation. In particular, if excitation is provided by direct illumination from within the superstrate or from below the substrate, most of the optical energy provided by the source can be used for excitation. Although this configuration improves the efficiency of excitation, it also holds some disadvantages. Namely, if a source of direct illumination is used, there may be luminescence generated in the superstrate by molecules other than those captured on the surface of the substrate, namely, by molecules in the superstrate further away from the interface of the substrate and superstrate. The latter luminescence would also be delivered to the detector causing difficulties in distinguishing between the luminescence generated at or close to the interface between the substrate and the superstrate, i.e. that emitting from the first layer and the luminescence generated further away from the interface in the superstrate itself, that originating in the second layer.

U.S. Pat. No. 4,810,658 describes a method of optical analysis of a test sample which utilises direct illumination to excite the sample. The resultant luminescence is coupled into a waveguide where it propagates along the waveguide until it exits at a side surface thereof. It is described how by selectively positioning the detector at angles about the optical axis of the waveguide that it is possible to attribute that detected light as being due to molecules bound to the surface of the waveguide. As this arrangement relies on the detection of light which has propagated within the waveguide, the emerging signal is an integration of luminescence captured along the waveguide and is therefore not suitable for discriminating between individual sources provided on the waveguide.

A further disadvantage is that the propagation of light within a waveguide requires multiple reflections on the side walls of the waveguide which leads to inevitable losses in intensity of the signal that is eventually detected. Such losses can reduce the sensitivity of the overall apparatus.

Yet a further disadvantage is the requirement for the detection system to be placed perpendicular to an end or side surface of the waveguide which increases the overall dimensions of the test configuration, thereby making it unsuitable for certain applications.

There is therefore a need for a system and method that can be used for the detection of surface-generated luminescence which employs the excitation of the luminescent molecules by direct illumination, i.e., using the full power of the source of the excitation light, and yet can be used to selectively discriminate between the source of the luminescence.

In this specification, the term “critical angle” is used in its conventional sense as being Arcsin N₂/N₁ or Sin⁻¹ N₂/N₁ where N₁ is the refractive index of the optically denser material called the substrate and N₂ is the refractive index of the less dense material, usually called the superstrate. Generally, the superstrate is the environment in which the surface binding or luminescent material is present, typically water or air. The condition N₂<N₁ must be satisfied.

The present invention is directed towards providing a means and apparatus for detecting that luminescence emitted into a substrate, which is emitted from molecules close to the superstrate/substrate interface but excited by direct illumination.

### STATEMENT OF INVENTION

According to the present invention, there is provided a luminescence-based sensor assembly comprising a superstrate; a substrate mounting an emitting layer capable of transmitting luminescence into the substrate; an excitation source; and a detector for measuring some of the emitted light in the substrate which is subsequently transmitted out of the substrate, characterised in that the excitation source provides direct illumination and the detected luminescence originates from a close vicinity of the superstrate/substrate interface.

Desirably, the excitation source is in the superstrate remote from the substrate. Typically the excitation source is provided above the substrate, although it will be appreciated that direct illumination may equally be effected by the provision of a source below the substrate.

The invention utilises the concept that the angular emission pattern from luminescent, typically fluorescent moieties depends strongly on proximity to the superstrate/substrate interface. Based on this, the invention applies angle-selective detection principles to discriminate between the luminescence from the surface-bound moieties and those located in the bulk of the fluid, that is to say, in the superstrate above the superstrate/substrate interface. Essentially, this is arranged by ensuring that only light transmitted into the substrate and propagating in a particular angular range above the critical angle of the superstrate/substrate interface is detected. Within the present invention the term “first layer” will be used to describe those moieties which are bound or adjacent to the substrate and whose luminescence is of interest, and the term “second layer” to all those other moieties.

Putting it in another way, a key feature of the present invention is that no light emerging from a sufficiently large distance above the substrate/superstrate interface, which emanates from inside the superstrate, can be propagated within the higher refractive index substrate at angles greater than the critical angle. However, when the source of the luminescence is close to the surface of the two materials, the radiation can be coupled into the waves propagating in the higher refractive index medium at angles greater than the critical angle. Consequently, detection of the luminescence in a particular range of angles greater than the critical angle provides the means of detecting the light originating from molecules located at or close to the surface.

One way of achieving this is by providing a light barrier in or on the substrate, which light barrier is arranged to block any light, which has been transmitted into the substrate at an angle below the critical angle.

Alternatively, the barrier can be mounted on the detector so that any light transmitted through the substrate from the emitting molecules at an angle below the critical angle, will be blocked from detection.

Another way of achieving the detection of the light radiated in the substrate at angles greater than the critical angle is to configure the substrate internally or externally so that only the light propagating at angles greater than the critical angle is redirected towards the detector.

Accordingly the invention provides a luminescent sensor configuration for use in a medium having a first refractive index, the sensor configuration comprising a source of direct illumination, a substrate having an upper and lower surface and being of a second refractive index, a material capable of luminescence, a detector arrangement provided below the lower surface of the substrate and adapted to detect light emitted through that lower surface, and wherein, in use, the medium and the substrate meet along the upper surface of the substrate which defines the boundary between the first and second refractive indices, the material capable of luminescence is excited by the source of direct illumination, thereby luminescing and the detector arrangement is adapted to discriminate between luminescent light emitted from a region within a predetermined distance of the upper surface and light emitted from any other regions, the discrimination being effected by selective detection of light emitted from the luminescent material at angles greater than the critical angle of the medium/substrate interface.

The angles greater than the critical angle are desirably angles within a specific range which are predetermined for optimum performance of the system.

Desirably, the predefined distance is within the range of upto about 4 λ, desirably about 0.5 λ to about 3 λ, and more preferably within the range of about 1 to about 2 λ, wherein λ is the wavelength of the luminescence light.

As detailed above, the luminescent molecules contained within the predefined distance may be considered as forming a first layer whereas those molecules or materials outside that distance may be considered as forming a second layer.

The angle at which the luminescence is emitted into the substrate and subsequently selectively detected is preferably further greater than a threshold angle, the threshold angle being an angle which satisfies the equation:
Iₛ(θₜᵣ)/I_{b}(θₜᵣ)=Fₜᵣ,
where Iₛ(θₜᵣ) is the intensity of light emitted from the first layer at the threshold angle, I_{b}(θₜᵣ) is the intensity of light emitted by the second layer at the threshold angle and Fₜᵣ is a confidence or performance factor which is selected by the user. I_{b}(θₜᵣ) typically corresponds to a background level within the configuration system such that the equation reduces to providing a threshold angle which satisfies the equation that the signal-to-background ratio of the measurement of the luminescence originating from the first layer is greater than some specified value Fₜᵣ.

The background level may in certain circumstances be considered a noise level for the system, although it will be appreciated that there are many different contributions within a system that may affect the overall background level.

In a first embodiment the first and second layers have the same refractive index. In an alternative embodiment, the first and second layers have a different refractive index.

In one embodiment, the light may be emitted into the substrate from more than one source and the detector arrangement is adapted to spatially discriminate between the origins or sources of the detected light.

Typically, the configuration includes at least one portion of capture material adapted to capture a specific target species, the at least one portion of capture material being coupled to the substrate and adapted, in use, to capture any of a predefined target substance within the medium, the capture or tagging effecting the formation of a captured species, which either directly or indirectly is adapted to luminescence upon excitation, such luminescence being detectable by the detector.

The captured species or material may be directly capable of luminescence or may require a subsequent combination with a further material to effect the formation of a luminescent source, thereby forming an indirect source of luminescence.

In certain embodiments at least two distinct portions of capture material are provided, each portion being coupled to the substrate and wherein the substrate is configured to redirect light emitted by each portion towards the detector such that the light received at the detector from a first portion is spatially independent from the light received at the detector from a second portion.

The light detected by the detector may be detected without undergoing total internal reflection within the substrate prior to detection.

Desirably, the detector arrangement includes at least one optical redirection element at either an upper or lower surfaces of the substrate, the optical redirection element adapted to redirect light emitted by the luminescent material into the substrate at an angle greater than the critical angle out of the substrate and towards a detector.

This at least one optical redirection element may be adapted to redirect the light using total internal reflection.

A plurality of optical redirection elements may be provided, each element comprising a frusto-conical structure raised above the upper surface of the substrate, each frusto-conical structure having side walls and an upper surface, luminescent material being carried on the upper surface of the structure, and wherein light emitted by the material into the structure is internally reflected by the side walls of the structure and directed towards a detector positioned beneath the substrate.

Alternatively, a plurality of optical redirection elements, each element in the form of a ridge raised above the upper surface of the substrate and extending along the upper surface of the substrate may be provided, the ridge having side walls and an upper surface, luminescent material being carried on the upper surface of the ridge, and wherein light emitted by the material into the ridge is internally reflected by the side walls of the ridge and directed towards a detector positioned beneath the substrate.

The at least one optical redirection element may be adapted to redirect the light using refraction. Such an element may be in the form of one or more prisms optically coupled, or integral, to a lower surface of the substrate, the prism being adapted to receive light incident on the lower surface of the substrate and redirect that light sidewardly towards a detector.

In another embodiment the at least one optical redirection element is adapted to redirect the light using diffraction, which may be provided by a diffractive optical element provided at the lower surface of the substrate.

The lower surface of the substrate may be structurally configured to both reflect and refract light radiated into the substrate, the reflection and refraction of the light effecting a redirection of light towards a detector, the light redirected being that light having propagating within the substrate at an angle greater than the critical angle of the substrate/medium interface.

The selective detection of light may be effected by providing the substrate with non-parallel upper and lower surfaces, the angle of the upper and lower surfaces being such that the light emitted by the luminescence material is incident on the surfaces at angles greater than the critical angle of the substrate/medium interface, thereby effecting a propagation of light along an axis of the substrate towards a detector.

The sensor configuration may be further modified so as to detect light radiated into the substrate by the luminescent material at angles which are not less than the critical angle of the luminescent material/substrate interface and greater than the critical angle of the medium/substrate interface.

The detector is desirably a CMOS, a CCD or a photodiode type detector, which can be located at a specific location below the substrate.

The sensor may be provided initially with a bio-recognition element, the bio-recognition element being sensitive to and adapted to couple with a compatible biological sample of preselected variety in the medium with which the sensor is used. In such element types, a combination of the bio-recognition element with the preselected sample variety effects the formation of a material capable of luminescence. In other element types, a sandwich assay is formed by a further coupling of the coupled biological sample/bio-recognition element with a luminescent tag or label to effect the formation of the luminescent material.

The invention arises out of our analysis of the radiation of dipoles placed above a higher refractive index substrate which reveals that the luminescence exhibits strong spatial anisotropy, with significantly greater amounts of luminescence radiated within a certain interval of angles. It has been appreciated by the present inventors that a significant amount of luminescence is radiated into the higher refractive index substrate at angles greater than the critical angle of the substrate/superstrate interface. Thus, in most substrates, a significant amount of the luminescence is radiated into the substrate and is trapped there. Accordingly, the idea is to provide a range of configurations which exploit these findings and ensures that the luminescence, instead of being trapped permanently within the substrate, is transmitted out of it for subsequent detection and measurement.

Our analysis of the radiation of dipoles placed above a higher refractive index substrate also reveals that the luminescence originating from molecules which are located further away from the substrate/superstrate interface than some specific distance, denoted by tₛ, cannot propagate within the substrate at angles greater than some specific angle, denoted by θₛ. However, the luminescence originating from molecules which are located within the distance tₛ above the substrate/superstrate interface can emit light which is propagating in the substrate at angles greater than θₛ.

In one embodiment of the invention, the luminescence-based sensor is so arranged that the light is directed through the exit surface substantially normally-thereto.

In another embodiment of the invention, at least either the upper surface mounting the emitter or the lower surface of the substrate is not planar. If planar, the surfaces are not parallel.

In one embodiment of the invention, the interfaces of the substrate are so configured that the internal reflection at the interface on which the light impinges is substantially prevented and allows the light to be transmitted through the substrate.

In another embodiment of the invention, the interfaces of the substrate are so configured that the light is reflected from at least one interface before being directed out of the substrate to the detector.

### BRIEF DESCRIPTION OF THE DRAWINGS

The invention will be more clearly understood from the following description of some embodiments thereof, given by way of example only, with reference to the accompanying drawings, in which:—

FIG. 1 shows the angular properties of luminescence radiated from a small luminescence spot located on a glass substrate; the substrate being surrounded by air below and by air above (FIG. 1a) and by water above (FIG. 1b),

FIGS. 2(A) and (b) are side views showing the effect of light generated at different distances from the surface of a substrate.

FIGS. 3a and 3b are side views of luminescence-based sensor assemblies according to the invention.

FIG. 4 shows the angular distributions of intensity of luminescence radiated by a dipole located in air (a) and water (b) at various distances t_{d} from the glass substrate.

FIG. 5 is a schematic diagram of a thin dipole layer (refractive index n₁=1.43, thickness t₁) deposited on a planar glass substrate, with the environment covering the layer being either air or water.

FIG. 6 shows angular distributions of intensity of the luminescence radiated from the configuration of FIG. 5, with the environment covering the layer being air (a) and water (b).

FIG. 7 is a schematic diagram of a two-layer system comprising a thin luminescent layer (refractive index n₁=1.43, thickness t₁) and a thin buffer layer (refractive index n₁=1.43, thickness t_{b}) deposited on a planar glass substrate.

FIG. 8 shows the angular distributions of intensity of the luminescence radiated into the glass substrate and originating from the two layer system of FIG. 7, with the system being covered by air (a) and water (b).

FIG. 9 shows schematic diagrams of two-layer systems consisting of a glass substrate, a sol-gel layer and a bulk layer, the structures being covered by water, with (a), (b) and (c) corresponding to the following situations: (a) the bulk layer contains luminescent molecules while the sol-gel layer does not; (b) the bulk layer does not contain luminescent molecules while the sol-gel layer does; (c) both the bulk and sol-gel layers contain luminescent molecules.

FIG. 10 shows the angular distributions of intensity of luminescence generated by a multilayer structure shown in FIG. 9, the graphs (a) and (b) correspond to the situations depicted in FIGS. 9(a) and 9(b), respectively with the different lines in FIG. 10(a) corresponding to different values of the thickness of the bulk layer t_{b} in FIG. 9(a), as indicated by the legend of the graph in FIG. 10(a).

FIG. 11 is an example of the angular distribution of intensity generated by a multilayer structure shown in FIG. 9(c), with different lines corresponding to different values of the thickness of the bulk layer t_{b} in FIG. 9(c), as indicated by the legend of the graph.

FIG. 12 is a schematic diagrams of a two-layer system consisting of a glass substrate covered with water, with (a), (b) and (c) corresponding to the following situations: (a) the bulk layer contains luminescent molecules while the surface layer does not; (b) the bulk layer does not contain luminescent molecules while the surface layer does; (c) both the bulk and surface layers contain luminescent molecules.

FIG. 13(a) shows angular distributions of the total intensity of luminescence radiated into the glass substrate, which is given as a sum of the contributions originating from the “surface” and “bulk” layers, with different lines corresponding to different values of the thickness of the bulk layer in FIG. 12(c), as indicated by the legend.

FIG. 13(b) shows the angular distribution indicating separate contributions to intensity of the luminescence originating from the surface layer of thickness tₛ (solid line) and the bulk layer of thickness t_{b} (dash-dotted line).

FIG. 14(a) shows angular distributions of the luminescence radiated by a 2-layer system depicted in FIG. 12(c) with the curves denoted by (BL) and (SL) corresponding to the situations where the luminescence originates from the bulk and surface layers, respectively.

FIG. 14(b) shows the threshold angle as a function of the surface layer thickness for two different values of the threshold factor Fₜᵣ.

FIGS. 15a to 15d show modified structures for detecting luminescence according to embodiments of the present invention.

FIG. 16 shows an exemplary array structure according to an embodiment of the present invention.

FIG. 17 shows an alternative array structure according to another embodiment of the present invention.

### DETAILED DESCRIPTION OF THE DRAWINGS

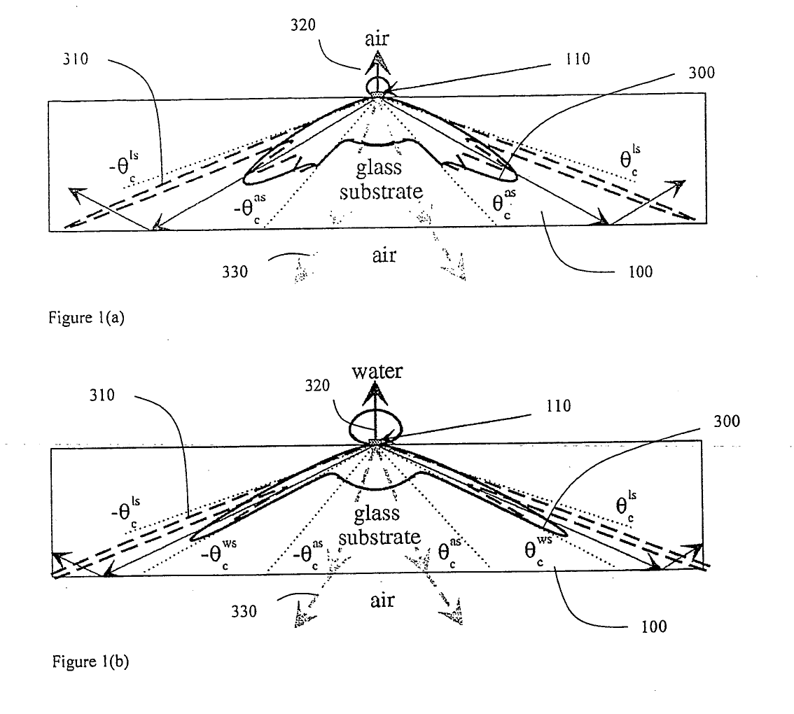

FIG. 1 shows an example of a sensing element. The same reference numerals will be used for the same components in the various embodiments. It consists of a “thick” glass slide substrate 100 (refractive index nₛ=1.515, thickness ˜1 mm) on top of which a small spot of luminescent material 110 (refractive index n₁=1.43) is deposited. It will be appreciated that the material is optically coupled to the substrate. By the term optically coupled it will be appreciated by those skilled in the art that it encompasses a plurality of different arrangements including, but not limited to:
i. luminescent molecules directly bound to or adsorbed on a substrate,
ii. luminescent molecules indirectly attached to substrate via one or more linker molecules (such as in a sandwich assay),
iii. luminescent molecules entrapped/contained within a thin film, for example a polymer or sol-gel matrix, coated on substrate.
iv. a layer of living cells containing luminescent centres, such as auto fluorescent bacteria.

The thickness t₁ of the layer forming the spot is assumed to be uniform and typically in the range of hundreds of nanometres. Typically, the dimensions of such a spot are determined by the application and will be defined by the user. Furthermore, for simplicity, the size of the spot is assumed to be small compared to the size of the area of the detection system, which is used to detect the luminescence produced by the spot. The latter restriction is assumed only to ensure that the luminescent spot “appears” to the detector as a spot rather than as an area over which the radiated intensity would have to be integrated. Consequently, the lateral (x-y) dimensions do not have to be considered and only the angular dependence of the radiated intensity needs to be taken into account in the following analysis. The luminescent spot is assumed to be covered by the environment, which is either air (nₐ=1.0) or water (n_{w}=1.33). The slide is surrounded by air from below.

The predicted angular distribution of the luminescence emerging from the small luminescent spot deposited on the glass substrate is shown in FIG. 1. The graphs (a) and (b) correspond to the situations where the environments or media covering the spot are air and water, respectively. In both graphs, the solid line 300 and the dashed line 310 correspond to the thickness of the luminescent spot equal to t₁=0.5λ and t₁=1.5λ, respectively, where λ is the luminescence wavelength. Luminescence that can be detected by the detector placed above the glass substrate is schematically shown by the arrow 320. Luminescence within this angular distribution is typical of the luminescence that has traditionally been used within sensor systems. As can be seen from the displacement of the luminescence as shown in the solid 300 or dashed 310 lines located in air or water above the glass substrate, the amount of luminescence radiated into the environment covering the spot is relatively small.

The situation is similar when the detector is placed below the glass substrate. Due to reflections taking place at the bottom glass/air interface, the light impinging at this interface is transmitted to air only if the incident angle lies within the angular range θε [symbol] −θ_{c}^{as},θ_{c}^{as} [symbol] , where θ_{c}^{as}=arcsin(nₐ/nₛ)≈413° is the critical angle of the substrate (glass)/air interface. This light is schematically depicted by the dashed arrows 330. Due to the refraction, the light propagating inside the substrate at angles θε [symbol] −θ_{c}^{as},θ_{c}^{as} [symbol] is partially transmitted into the air under the substrate at angles θε [symbol] −90°,90° [symbol] . The solid 300 and dashed 310 lines within the angular range θε [symbol] −θ_{c}^{as},θₓ^{as} [symbol] demonstrate that the amount of luminescence transmitted to air below the glass substrate is also relatively small.

The light propagating inside the substrate at angles greater than the critical angle θ_{c}^{as} is totally internally reflected t the lower substrate/air interface. If the environment covering the slide is air, as shown in FIG. 1(a), this light is also totally internally reflected at the upper layer/air interface and is effectively trapped (or confined) within the waveguiding glass substrate. If the environment above the slide is water, as shown in FIG. 1(b), the part of the light propagating in the substrate at angles θε [symbol] θ_{c}^{as},θ_{c}^{ws} [symbol] and θε [symbol] −θ_{c}^{as},−θ_{c}^{ws} [symbol] is partially transmitted into water and partially reflected back to the substrate. Furthermore, the part of light propagating at θε [symbol] θ_{c}^{ws},90° [symbol] and θε [symbol] −θ_{c}^{ws},−90° [symbol] is totally reflected at the upper layer/water interface. In any case, due to the relation θ_{c}^{ws}>θ_{c}^{as}, the light exhibiting the enhanced intensity is always trapped inside the substrate due to the total internal reflection at both the upper and lower interfaces. For the ease of explanation the term θ_{c}^{es}, can be taken as being equivalent either to θ_{c}^{as} or θ_{c}^{ws} depending on whether the environment covering the luminescent spot is air or water.

The above analysis of the radiation properties of light propagating indicates that the propagation of the light within the substrate is independent of the way the radiation was excited. It will be understood therefore that any type of excitation, which would provide the same spatial distribution of the radiating molecules, would result in the same characteristics of the radiated luminescence.

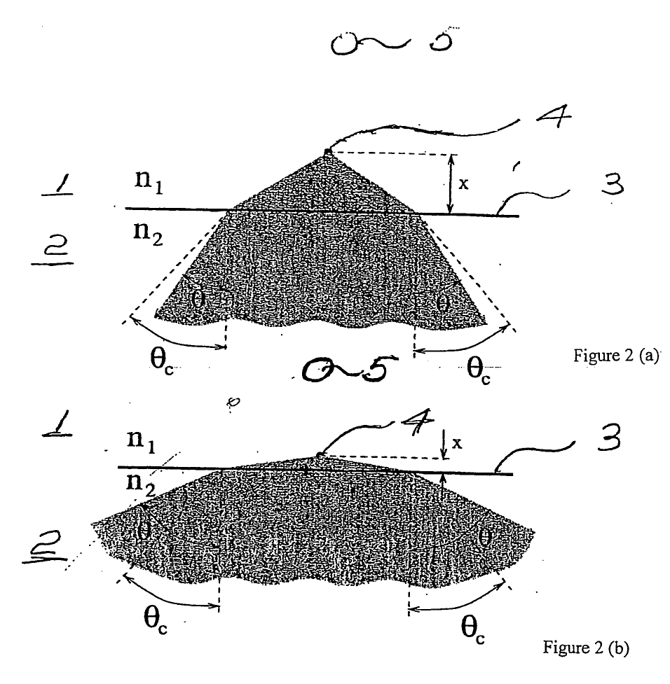

Referring to FIG. 2, there is illustrated a superstrate 1 above a substrate 2 having a surface 3 forming a superstrate/substrate interface and a luminescent source 4, for example, any form of luminescent molecule. An excitation source, namely, a light source 5 is mounted above the surface 3 and spaced-apart therefrom. The luminescence source 4 is illustrated in FIG. 2(a) and (b) at different distances X from the surface 3. Further, the superstrate 1 has a lower refractive index N₁ than the substrate 2 which has a refractive index N₂, i.e. N₂>N₁.

Referring now to FIG. 2(a), when the light source 5 causes the luminescent source 4 to emit light, it will be noted that the light is emitted at a distance X, considerably greater than λ, which is the wavelength of the light being emitted. That light from the luminescence source 4 does not propagate into the substrate 2 at angles greater that the critical angle θ_{c}. In practice, the fraction of luminescence light in the higher luminescence refractive index substrate at angles greater than the critical angle θ_{c} decreases rapidly as distance X increases. Therefore, if X is chosen to be sufficiently large, for example, X>2λ, the amount of light propagating in the substrate at angles greater than the critical angle is negligible. However, referring to FIG. 2(b), if the luminescent source 4 is at a small distance from the superstrate/substrate interface, for example, X<λ, then a significant fraction of the luminescence light will propagate in the substrate in the range of angles above the critical angle θ_{c}.

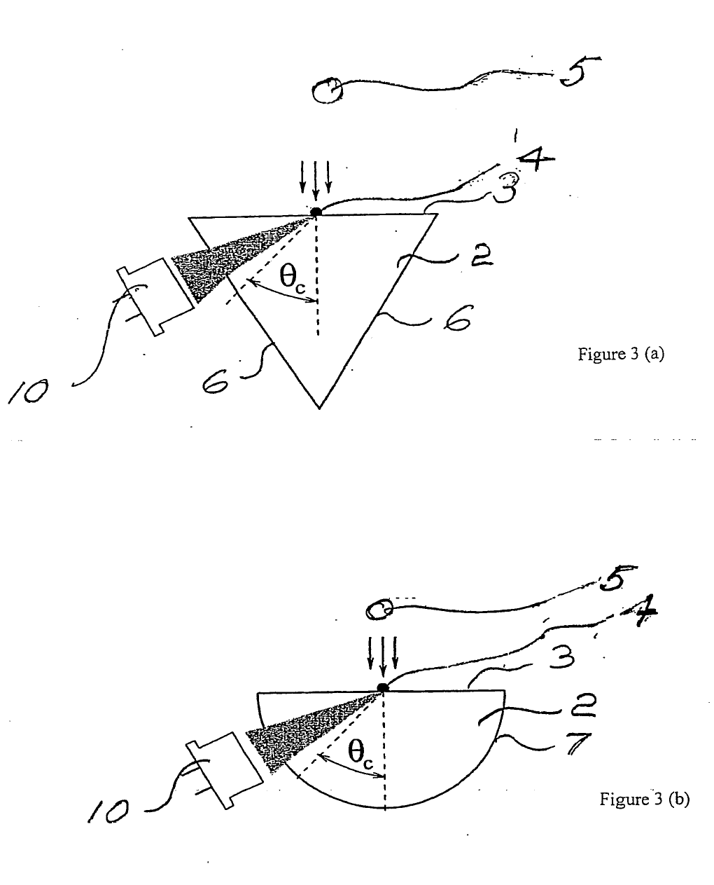

Referring to FIGS. 3a and 3b, with parts similar to those described with reference to the previous drawings being identified by the same reference numerals, two embodiments of the present invention are illustrated. In these embodiments, the drawings are identified by the same reference numerals. In the embodiment of FIG. 3a, the excitation source 5 is again placed above the substrate 2 which is in the form of a prism. A luminescent source 4 is attached to the surface 3. A photodetector, in this embodiment, a CCD camera 10, is mounted adjacent one of the planar surfaces 6 of the substrate 2 for capture of light propagated in a particular range of angles above the critical angle θ_{c}. In the embodiment of FIG. 3b the substrate, again identified by the reference numeral 2, is again in the form of a prism having an arcuate lower surface 7. The prism is adapted to direct light propagating within a range of angles above the critical angle from the luminescence source 4 onto the detector 10. Due to the configuration of the prism surface the light that is propagating within the substrate, although it may be at angles greater than θ_{c} is incident on the surface of the prism at angles less than the critical angle and is therefore able to out-couple from the substrate and may be detected.

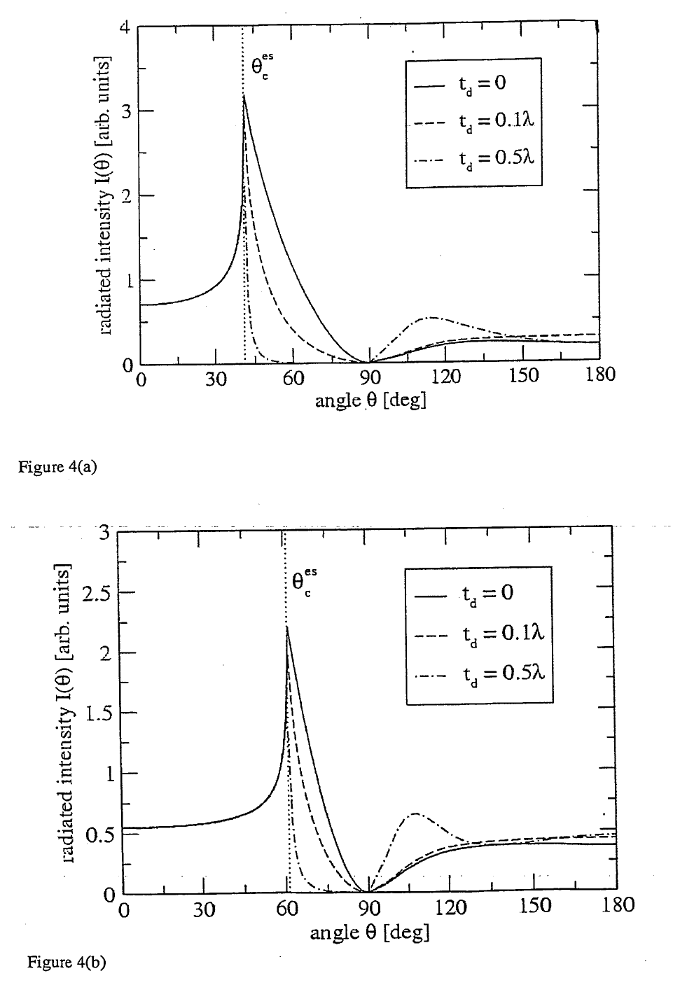

If one assumes the luminescent source to behave as a radiating dipole such as what is described in Polerecky et al (Applied Optics 39 (22): 3968-3977 Aug. 1, 2000), it can be shown that the angular distribution of the intensity of the light radiated below the critical angle does not appreciably change with the distance of the dipole from the substrate. FIGS. 4a and 4b, which correspond to the situation where the environment covering the substrate is air and water respectively, show the angular distributions of intensity of the radiated luminescence for three distances of the radiating dipole from the glass substrate-corresponding to distances equivalent to 0, 0.1λ and 0.5λ.

As can be seen from the graphs in FIG. 4, the angular distribution of the intensity radiated below the critical angle θ^{es}_{c} does not change with the distance t_{d} of the dipole from the glass substrate. The intensity radiated into the environment, i.e., at angles θε [symbol] 90°,180° [symbol] varies in that its total amount increases with increasing value of t_{d}.

Furthermore, a peak starts emerging at θ≈110° for greater values of t_{d}. Although the present invention is not intended to be limited to any one specific theory it is thought that this is due to interference of the luminescence radiated directly into the environment and that reflected from the environment/substrate interface. The number of these peaks, which form a fringe-like pattern in the angular distribution of the intensity, would increase with increasing distance td (not shown in the Figure).

The most significant changes in the intensity profile are observed within the angular range θε [symbol] θ_{c}^{es},90° [symbol] , where θ_{c}^{es} is either θ_{c}^{as}=41.3°or θ_{c}^{ws}=61.3°, depending on whether the environment is air or water, respectively. In particular, the intensity fall-off above the critical angle is more abrupt for greater distances t_{d}. Furthermore, for a distance as low as t_{d}=0.5λ, there is almost no luminescence radiated above the critical angle θ_{c}^{es}, as shown by the dash-dotted line. These important features can be explained as follows. The electromagnetic field, which propagates in the glass substrate at angles θε [symbol] θ_{c}^{es},90° [symbol] is exponentially decreasing in the environment. A characteristic penetration depth of this so-called evanescent field is approximately λ and it decreases with the increasing propagation angle θ. Because the luminescence at these angles is provided by coupling of the dipole's near-field with the evanescent field, it is understandable that its intensity is decreasing for increasing θ. Moreover, for a sufficiently large distance of the dipole from the surface, the evanescent field does not reach the dipole's position. This implies that there is very little luminescence radiated above the critical angle for such large distances due to a weak coupling of the evanescent field and the dipole's near-field, as concluded above.

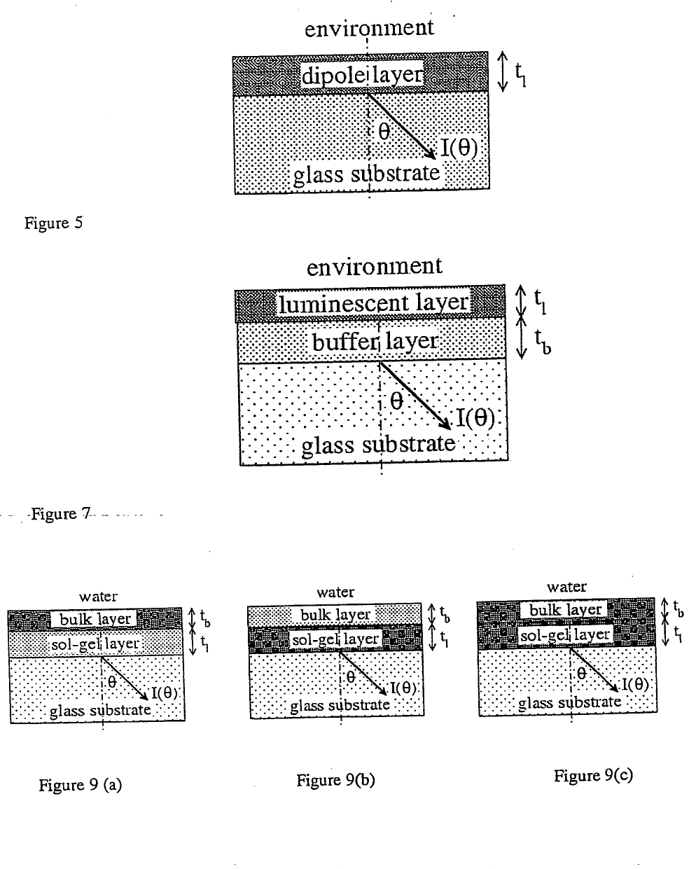

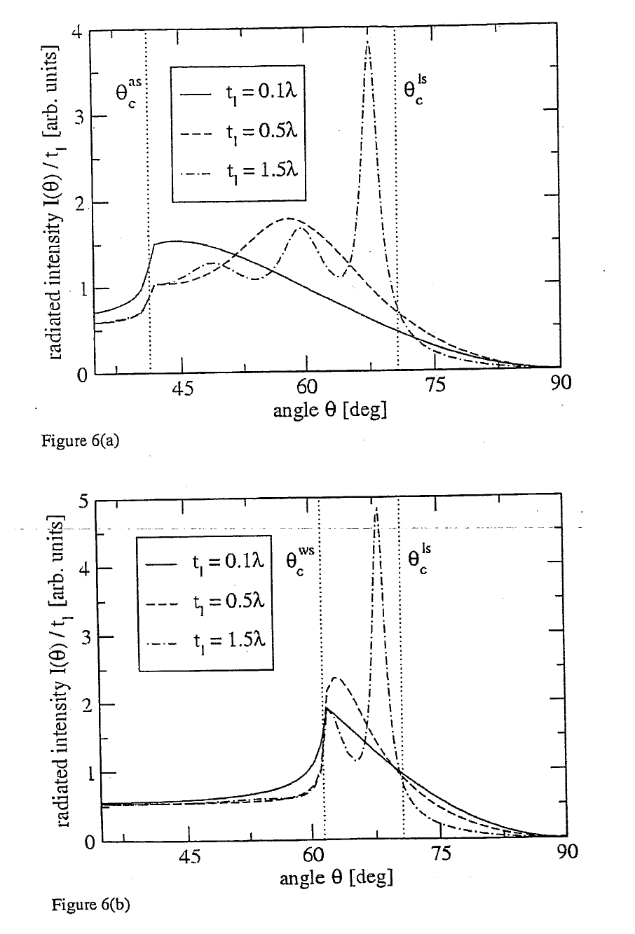

The above description was with reference to a single radiating dipole provided at various distances above a substrate. FIGS. 5 and 6 show an analysis of varying the thickness of a thin dipole layer deposited on a planar glass substrate, with the environment being either air (FIG. 6a) or water (FIG. 6b). FIG. 6 shows the angular distributions of intensity of the luminescence radiated from the luminescent layer whose thickness takes values t₁=0.1λ, 0.5λ, and 1.5λ, where λ is the wavelength of luminescence. Only the intensity radiated into the glass substrate is shown. As can be seen, the angular distribution at angles below the critical angle θ_{c}^{es} does not change significantly with the thickness of the dipole layer, and is close to that corresponding to the point dipole radiation described above with reference to FIG. 4.

Notable changes are observed at angles θε [symbol] θ_{c}^{es},θ_{c}^{is} [symbol] ; where θₓ^{is}=arcsin(n₁/nₛ)≈70.7° is the critical angle of the layer/substrate interface. Within this angular range, the angular distribution of intensity exhibits a distinct peak. This peak is more pronounced and shifted towards θ_{c}^{is} for greater values of the thickness of the dipole layer. Furthermore, at these greater thickness', the sharp peak is accompanied by several less significant peaks, which “emerge” from the angular position determined by θ_{c}^{es}. This is demonstrated by the dash-dotted line in FIG. 6(a). This feature is not yet visible in FIG. 6(b) as the thickness of the luminescent layer is not sufficiently large.

The behaviour of the radiated intensity described above can be qualitatively understood by considering the following arguments. The electromagnetic field, which corresponds to the modes propagating in the glass substrate at angles θε [symbol] θ_{c}^{es},θ_{c}^{is} [symbol] is propagating within the dipole layer. Due to interference effects caused by the reflections at the substrate/layer and layer/environment interfaces, the magnitude of the field can be considerably enhanced for a certain value of the angle θ. The coupling efficiency between the near-field of the dipoles inside the layer and the far-field propagating in the glass is proportional to the magnitude of the field inside the dipole layer. Therefore, the enhancement of the radiated intensity at a particular angle θ is a consequence of the enhancement of the field corresponding to the modes propagating at this angle.

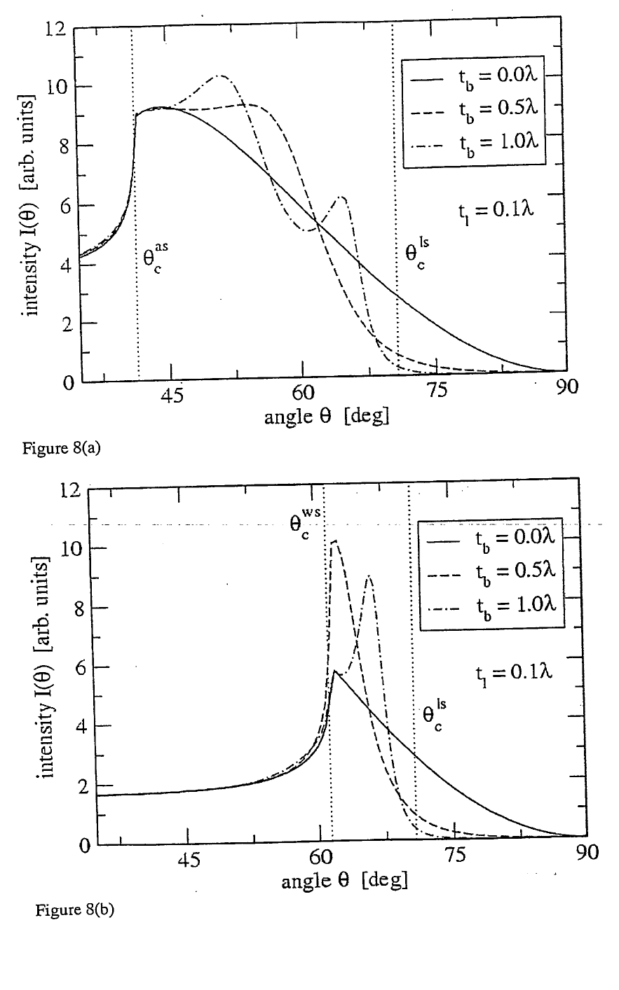

FIGS. 7 and 8 show an extension of this analysis to a two-layer system comprising a glass substrate covered by a buffer layer of refractive index n_{1=1.43} and variable thickness t_{b}. On top of the buffer layer is provided a luminescent dipole layer of refractive index n₁=1.43 and thickness t₁=0.1λ. The luminescent layer is covered by an environment, which is either water or air. This specific example illustrates the influence of a buffer layer thickness on the angular profile of intensity of the radiated luminescence.

The angular dependence of intensity of the luminescence radiated into the glass substrate is shown in FIG. 8. The graphs (a) and (b) correspond to the situations where the luminescent layer is covered by air and water, respectively. The thickness of the buffer layer varies between t_{b}=0λ; 0.5λ, λ. As can be seen, the influence of the buffer layer on the angular profile of the radiated intensity is two-fold. Firstly, in the angular range θε [symbol] θ_{c}^{es},θ_{c}^{is} [symbol] , the smooth decrease of the intensity with the increasing angle θ is changed to a more complex profile containing peaks and dips, the number of which depends on the thickness t_{b} of the buffer layer. These peaks are due to the same interference effects as those discussed above with reference to a layer deposited directly on the substrate. The second important influence of the buffer layer can be observed at angles above the critical angle θ_{c}^{is} of the buffer layer/substrate interface. The total amount of luminescence radiated above this angle is decreased substantially even for as thin a buffer layer as t_{b}=λ (see the dash-dotted line). This is due to the same reasons as already discussed above.

In particular, the field corresponding to the intensity observed at these angles is evanescent in the buffer layer. When the thickness of the buffer layer is sufficiently large, the field barely reaches the luminescent layer, which decreases the coupling efficiency between the near-field of the radiating dipoles and the radiated field. Consequently, the amount of luminescence propagating in the glass substrate at angles θ>θ_{c}^{is} is very small for greater values of t_{b}.

FIG. 9 illustrates an exemplary configuration similar to that discussed in the previous section. The results obtained from this numerical analysis are particularly applicable to practical applications where the surface-generated luminescence is of interest. The two-layer system consists of a glass substrate, which is covered by a sol-gel layer of refractive index n₁=1.43 and thickness t₁=1.5λ. It will be appreciated that the values presented here are exemplary of the values that may be used in configurations and it is not intended to limit the present application to any particular value of n₁ or t₁; n₁ simply has to be smaller than the refractive index of the substrate and greater than the refractive index of the superstrate, and that the values give here are illustrative of typical values. This layer is either luminescent or non-luminescent. On top of this layer is a bulk layer of water (thickness t_{b}), which either does or does not contain luminescent molecules. The purpose of this bulk layer is to model the contribution to the radiated luminescence originating from the volume above the thin sol-gel layer. The bulk layer is covered by water free of luminescent molecules.

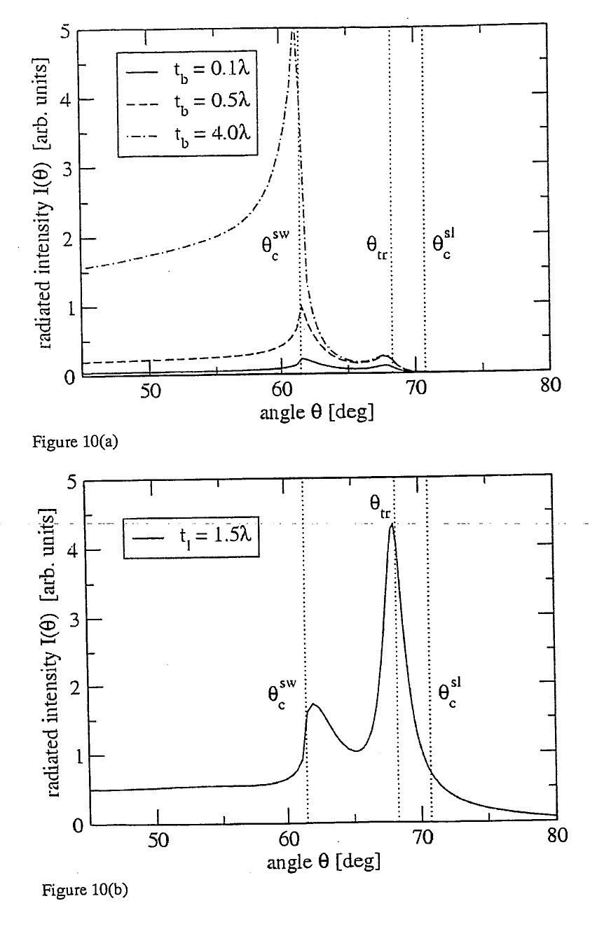

Firstly, it is considered that the sol-gel layer does not and the bulk layer does contain luminescent molecules, as shown in FIG. 9(a). The corresponding angular profile of intensity of the luminescence radiated into the glass substrate is shown in FIG. 10(a). As can be seen, the luminescence radiated from the bulk layer can be observed mainly at angles below the critical angle of the water/substrate interface (θ_{c}^{ws}). The greater is the thickness t_{b} of the bulk layer, the greater is the amount of luminescence observed below the critical angle θ_{c}^{ws}.

On the other hand, the contribution of the bulk layer to the luminescence observed within the angular range θε [symbol] θ_{c}^{ws},θ_{c}^{is} [symbol] is small and does not significantly change when the bulk layer thickness exceeds the value of approximately 4λ, as demonstrated by the dash and dash-dotted lines in FIG. 10(a). This is an important observation because it enables one to extend the thickness of the bulk layer to an arbitrarily large value without modifying the angular distribution of the luminescence radiated within this angular range. It should also be noted that there is only a negligible contribution of the bulk layer to the luminescence observed above the critical angle θ_{c}^{is}.

If one considers the opposite case, i.e. where the sol layer does and the bulk layer does not contain luminescent molecules, which is shown in the example of FIG. 10b, then it can be shown that the main contribution to the luminescence originating from the sol-gel layer is observed at angles θε [symbol] θ_{c}^{ws},θ_{c}^{is} [symbol] . Furthermore there is a considerable amount of luminescence radiated above the critical angle θ_{c}^{is}.

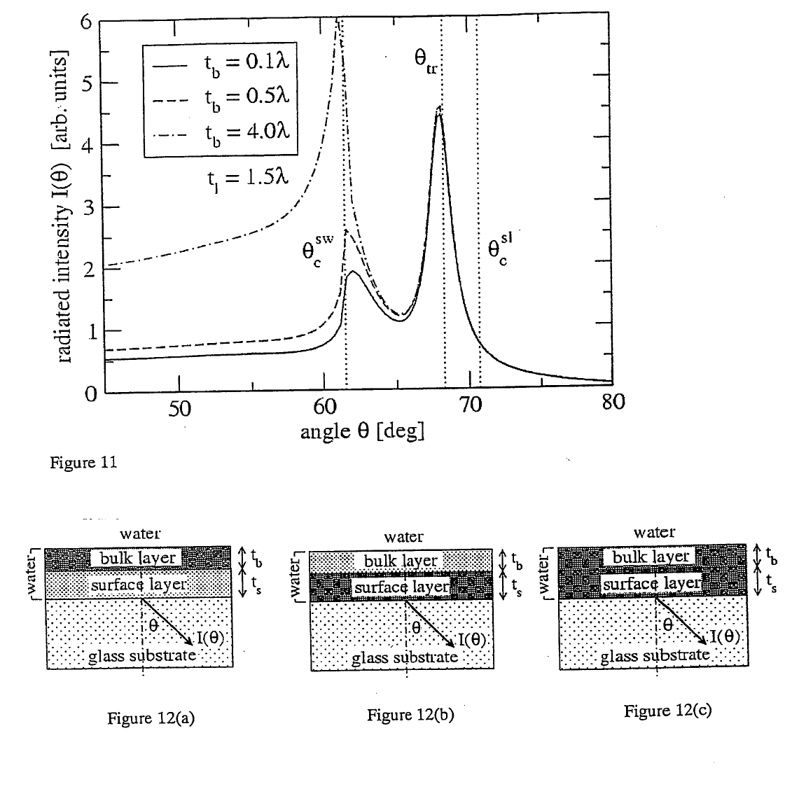

In the scenario where both the sol gel layer and the bulk layer contain luminescent material and assuming that both the layers have equal densities of molecules, as is shown in FIG. 9(c), then the angular distribution of intensity resembles that shown in FIG. 11. Due to the fact that the contributions to the luminescence originating from different parts of the structure are considered to be uncorrelated (in the statistical sense), the total intensity is given by the sum of the contributions from the sol-gel and bulk layers.

It will thus be appreciated that the graph demonstrates that it is possible to distinguish between the contributions originating from the doped sol-gel layer and the luminescent bulk layer. This is due to the fact that these two contributions are observed within different angular regions. In particular, the main contribution originating from the bulk layer is radiated at angles below the critical angle θ_{c}^{ws}, while the main contribution originating from the thin sol-gel layer is observed at angles above the critical angle θ_{c}^{ws}. Although the distinction between the two contributions is not sharp around the critical angle θ_{c}^{ws}, there is a definite angle, denoted by θₜᵣ, above which the contribution originating from the bulk layer is negligible in comparison to the contribution originating from the sol-gel layer. The value of this angle can be determined by combining this analysis and the background signal characteristics of the particular detection system. It will therefore be appreciated that by applying the technique of the present invention that it is possible to discriminate in the light detected at a detector where that light originated, i.e. whether it is due to luminescence of luminescent molecules in a region close to the substrate interface or whether it is due to the luminescence of the molecules outside that region.

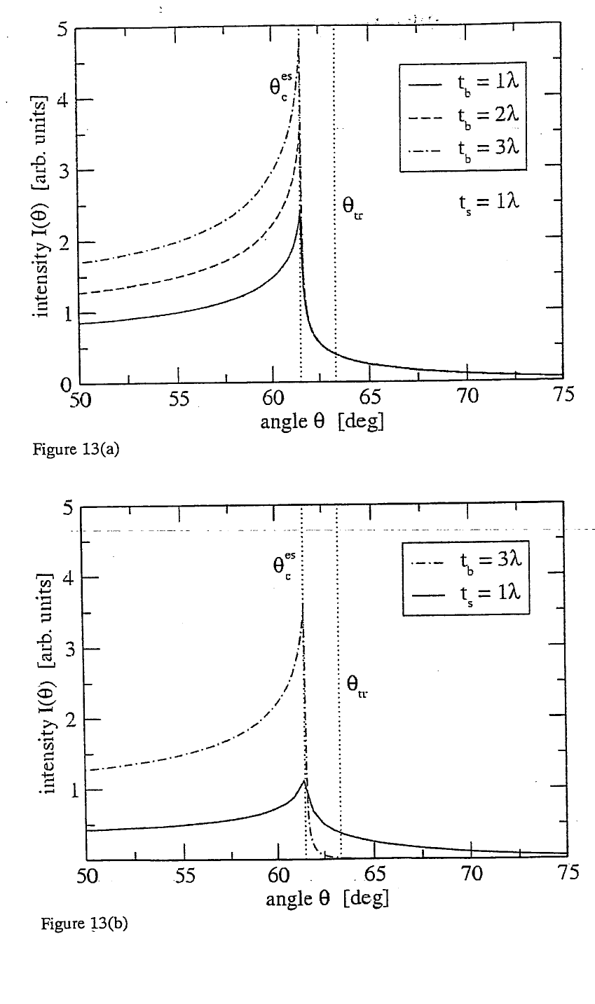

FIG. 12 shows the application of the analysis relating to the dipole activity between a surface and bulk contribution so as to provide for a technique suitable for distinguishing between the surface and bulk-generated luminescence. Such application has particular importance in sensor applications which are used in an in situ environment where the sample being tested is flowing through the cell and the user wishes to discriminate in real time between the luminescence originating from the molecules located near the substrate/environment interface and that originating from the molecules still flowing through the cell. The structure under consideration consists of a glass substrate covered by water. The water environment is formally divided into a “surface” layer, a “bulk” layer and the bulk itself. This formal division has been introduced to enable the modelling of the properties of the luminescence originating from the bulk located above the surface layer, and is representative of a region within a predetermined distance of the interface on the medium side of the interface and a second region out side that predetermined distance. The surface layer is a layer of water of thickness tₛ adjacent to the glass substrate. The bulk layer is another layer of water (thickness t_{b}) covering the surface layer. The purpose of this division is to model the contributions to the radiated luminescence originating from molecules located close to the surface of the substrate and those located further away from the surface. The situation is depicted in FIG. 12. Firstly, it is assumed that both the surface and bulk layers contain luminescent molecules. This means that the luminescence originates from a layer of thickness tₛ+t_{b}, as shown in FIG. 12(c). The angular distribution of intensity of the luminescence radiated into the glass substrate from such a system is shown in FIG. 13(a) for tₛ=λ and various values of the bulk layer thickness (see the legend of the graph). As can be seen, the increased value of the bulk layer thickness results only in increase of the level of luminescence intensity essentially below the critical angle of the environment/substrate interface θ_{c}^{es}. Above this angle, the intensity of luminescence remains practically unchanged for all values of the bulk layer thickness t_{b}.

To explain this behaviour, the contributions originating from the surface and bulk layers are plotted separately.

This is shown in FIG. 13(b) by the solid and dash-dotted lines, respectively. The dash-dotted line indicates that the luminescence originating from the bulk layer falls rapidly above the critical angle θ_{c}^{es}. Above the threshold value of the observation angle θₜᵣ, the luminescence intensity arising from the bulk is negligible in comparison with the contribution of the surface layer. As follows from the graphs (a) and (b) in FIG. 13, it is the surface layer that contributes to the luminescence radiated well above the critical angle θ_{c}^{es} or, more precisely, above the threshold angle θₜᵣ. Therefore, by defining the value of θₜᵣ and observing the angular distribution of the luminescence radiated into the (higher refractive index) substrate above θₜᵣ, a detection technique which is the subject of the present invention can be established. Employing this technique, one can distinguish between the luminescence originating from the surface layer and the luminescence originating from the bulk covering the surface layer. The thickness of the surface layer has to be determined by the particular application exploiting this principle. Once it is known, the threshold angular position θₜᵣ can be calculated.

Using the technique of the present invention it is possible to distinguish between surface bound and bulk molecules which are luminescently labelled, which is of particular interest to biosensors. This has specific application in such biosensors in order to discriminate between surface-bound and bulk molecules which are luminescently labelled.

Using such an ability to distinguish the origin of the luminescence enables the present inventors to provide a method and technique which is adapted to enable detection of the luminescence originating from a region adjacent to the substrate interface and excited by a direct illumination. The thickness of the region of interest, which is in the order of the luminescence wavelength λ, can be tailored according to the needs of a particular application.

In the following analysis, the substrate is considered to be made of glass (nₛ=1.515) and the environment containing the luminescent species is water (n_{w}=1.33). Similar conclusions can be, however, drawn for any other set of parameters, as will be apparent to those skilled in the art. As was detailed above the detection of the luminescence originating from a thin layer adjacent to the (glass) substrate, i.e., the surface layer, can be achieved by measuring a specific fraction of the luminescence, in particular that propagating in the (glass) substrate above the threshold angle θₜᵣ. This conclusion is demonstrated in FIG. 13(b) where the difference between the angular profiles of the luminescence originating from the surface layer of thickness tₛ=λ (solid line) and the bulk layer of thickness t_{b}=3λ (dash-dotted line) are clearly visible. From the application point of view, it is important to know the relation between the thickness tₛ of the surface layer from which the luminescence originates and the threshold angle θₜᵣ above which the luminescence should be observed.

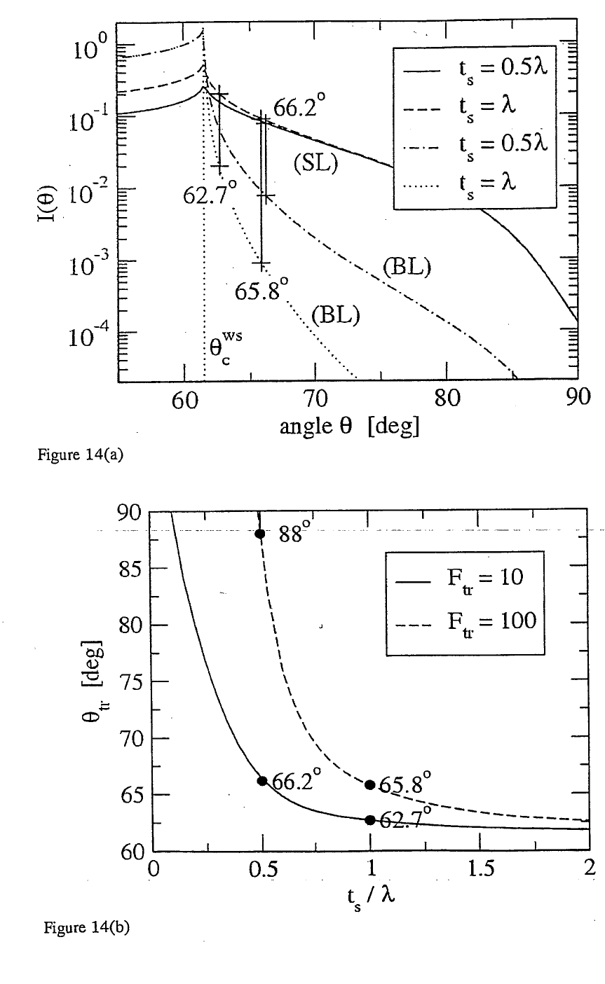

FIG. 14(a) shows the angular distributions of the luminescence radiated from a 2-layer system depicted in FIG. 12. The distributions are plotted for two values of the surface layer thickness, namely tₛ=0.5λ and tₛ=λ, and for one value of the bulk layer thickness, namely t_{b}=3λ. In order to see the relative relation between the various curves, the y-axis employs a logarithmic scale. From FIG. 14(a), it can be seen that there is a significant difference between the contributions to the luminescence originating from the surface and bulk layers, particularly above the critical angle θ_{c}^{ws} of the water/substrate (glass) interface. While the intensity corresponding to the bulk layer decreases abruptly for θ>θ_{c}^{ws}, this decrease is not so rapid for the intensity corresponding to the surface layer. Furthermore, the rate of this decrease varies with the thickness of the surface layer, which is the fundamental feature that can be exploited for determining the relation between tₛ and θₜᵣ. The threshold angle θₜᵣ can be defined as the angle above which the ratio between the intensity of the luminescence originating from the surface layer (Iₛ) and that originating from the bulk layer (I_{b}) is greater than a specified threshold or performance factor Fₜᵣ: i.e.
Iₛ(θₜᵣ)/I_{b}(θₜᵣ)>Fₜᵣ

Accordingly θₜᵣ can be defined as that angle which provides for the left-hand and right-hand sides of the above equation to be equal and the configurations developed in this application use the detection of light above this angle.

It will be appreciated that in most practical applications, the intensity of luminescence is always characterised by some non-zero background signal. These background signals may have contributions from electronic and other sources of noise, and represent a threshold value above which it is possible to detect a signal. Therefore, the value of θₜᵣ can be chosen in such a way that I_{b}(θₜᵣ) within the above equation corresponds to this background level. Consequently, the definition above is simply a formal expression of the requirement that the signal-to-background ratio of the measurement of the luminescence originating from the surface layer be greater than some specified value Fₜᵣ. This also justifies the definition of θₜᵣ given by the equation. It can be seen from FIG. 14(a) that the intensity of the luminescence originating from the surface layer of thickness tₛ=λ is 10 times greater at θₜᵣ=62.7° and 100 times greater at θₜᵣ=65.8° than the intensity of the luminescence originating from the bulk layer. Therefore, by measuring the luminescence at angles θ≧62.7° and θ≧65.8°, the certainty that only the luminescence originating from the surface layer of thickness tₛ=λ is measured is 10 and 100, respectively.

It will be appreciated that the choice of threshold angle is dependent on the configuration parameters but also on the confidence factor that is required by the user. This choice of threshold angle is provided by an analysis of the values of the threshold angles required to ensure that only the luminescence from within the surface layer is detected. As was detailed above this is provided by an examination of the values provided by the graphical output of FIG. 14(b). The values provided by FIG. 14(b) enable a calibration of the desired configuration. This calibration is provided based on an understanding of the parameters/factors contributing to the differentiation. This can be considered as a multi-step process:
1. The refractive indices of the materials involved in the particular application need to be known, namely ns of the substrate, nₑ of the environment and, optionally, n₁ of the thin surface layer, if different from nₑ. These are specific to the configuration being used and can typically be found from the specification of the relevant materials and, in case of nₑ, need to be either estimated or measured by other means.
2. The particular application will dictate the value of the thickness t₁ of the layer adjacent to the substrate/superstrate interface, i.e., the surface layer, which is of interest. This will also be defined by the application process and will be determined by the user.
3. The application will also dictate the so-called analytical wavelength λ of luminescence, which is the wavelength where the luminescence intensity upon excitation by a certain light source is maximum.
4. Finally, the threshold factor Fₜᵣ should be supplied by the user, which determines the level of confidence with which the luminescence originating from the surface layer and that originating from the surrounding bulk are to be distinguished.
5. From the values of nₛ, nₑ, n₁, tₛ and λ supplied from steps 1-3, it is possible to defines a multilayer system such as that depicted in FIG. 9 (the scenario where case nₑ is not equal to n₁) or in FIG. 12 (the scenario where nₑ=n₁). One also defines the value of the thickness t_{b} of the bulk layer. This value is, in principle, an arbitrary value and greater than about 4λ, but in practice it will be appreciated that the thickness of the bulk layer may be significantly greater than the thickness of the layer of interest. This layer is utilised to determine an optimum threshold angle for the specific application and provides for an identification of the radiation originating from the bulk located above the surface layer.
6. In the following, it is assumed that nₑ and n₁ are not equal, but it will be apparent to the person skilled in the art that the same steps could be carried out if nₑ and n₁ are equal.
7. Utilising the techniques provided by the model described in the article (Polerecky et al, Applied Optics, 2000), or any equivalent model as will be appreciated by those skilled in the art, enables one to evaluate the angular distribution of luminescence intensity radiated from the molecules located in an arbitrary multilayer system.
8. Firstly, the situation in FIG. 9(a) is considered, i.e., the bulk layer is assumed to contain radiating molecules while the surface layer not. Using such a modeled set of parameters, the angular distribution of luminescence radiated from such a structure is calculated and a curve similar to the dash-dotted curve in FIG. 10(a) is obtained.
9. Secondly, the situation in FIG. 9(b) is considered, i.e., the surface layer is assumed to contain radiating molecules while the bulk layer not. Using the modeled parameters, the angular distribution of luminescence radiated from such a structure is calculated and a curve similar to the solid curve in FIG. 10(b) is obtained.
10. The curves corresponding to the calculations in points 9 and 8 are divided, i.e., the ratio between the intensities of the luminescence originating from the surface and bulk layers may then be calculated. Subsequently, the value of the angle at which this ratio is equal to the threshold factor Fₜᵣ specified in point 4 is determined. This angle is equal to the threshold angle θₜᵣ. This parameter can subsequently be used as the parameter defining the experimental conditions at which the method of this specification is used.

It will be appreciated that this initial definition of the optical properties of the system configuration enables one to perform a calculation of the angular distribution of the radiated luminescence. Once this distribution is calculated, the value of the thickness t₁ is chosen, according to the requirements of the application, the performance factor is chosen and then the threshold angle can immediately found.

As follows from the curves in FIG. 14(a) calculated for a different value of tₛ, the value of the threshold angle θₜᵣ varies with the desired thickness of the surface layer. For example, θₜᵣ=62.7° for tₛ=λ and Fₜᵣ=10 but it increases to θₜᵣ=66.2°for tₛ=0.5λ and Fₜᵣ=10. Therefore, from the practical application point of view, it is necessary to establish the relation between tₛ and the corresponding value of θₜᵣ. Understandably, this relation is parameterised by the threshold factor Fₜᵣ. An example of θₜᵣ as a function of tₛ is shown in FIG. 14(b), where the solid and dashed lines correspond to Fₜᵣ=10 and Fₜᵣ=100, respectively. The graph implies that, for example, if an application requires that only the luminescence originating from a surface layer of thickness tₛ=0.5λ and tₛ=λ be detected with a certainty characterised by Fₜᵣ=10, the detector should measure only the luminescence radiated at angles greater than θₜᵣ=66.2° and θₜᵣ=62.7°, respectively. These angles increase to approximately 88° and 65.8°, respectively, if a greater level of certainty, namely Fₜᵣ=100, is required. The graph in FIG. 14(b) also shows that there are some limits with regard to the minimum thickness of the surface layer that can be resolved by this method. For example, the luminescence originating from a surface layer thinner than approximately 0.2λ cannot be detected with a certainty level of Fₜᵣ≧10, as indicated by the solid line which is not defined for tₛ <≈0.2λ, This minimum thickness is increased to ≈0.5λ if the certainty level is increased to 100. This feature is related to the fact that the penetration depth of the evanescent field is greater than zero even for an incident angle approaching or equal to 90°. The graph also shows that if the surface region of thickness not exceeding tₛ=2λ is of interest, it can be probed with a high certainty (Fₜᵣ=100) by measuring the luminescence radiated above approximately 65°. This value is sufficiently small to be accessible by a simple experimental set-up, such as that detailed below.

It is important to emphasise that the excitation of luminescence was not mentioned in the above analysis at all. This is because the angular properties of the emitted luminescence, which are exploited in this technique, are independent of the way how the luminescent molecules are excited. Therefore, it is possible to use direct illumination for efficient excitation of the molecules while detecting the luminescence originating specifically from a close vicinity of the surface. This is what makes this technique very attractive.

It will be appreciated that application of the technique of the present invention enables one to extract information from areas where the luminescence of interest is that generated specifically by the molecules located in close vicinity to the surface. In particular, the present invention provides a method for the detection of such luminescence. In contrast to the conventional method that employs evanescent-wave excitation, this method enables one to use direct illumination to excite the luminescent molecules. The distinction between the luminescence radiated by molecules located in the bulk and near the surface is achieved by the measurement and appropriate treatment of the angular profile of luminescence intensity. In particular, by measuring the emitted luminescence above a certain threshold angle θₜᵣ, only the luminescence originating from molecules located closer to the surface than some corresponding distance tₛ is detected. Taking into account that the excitation by direct illumination is much more efficient than that provided by the evanescent-wave excitation technique, for reasons including that more of the emitted light from the light source can be used for exciting the luminescence material, the method of the present application can be particularly attractive in immunosensing applications.

It will be appreciated that the above description identifies that, using the method of the present invention, it is possible to differentiate between the source of luminescence, i.e. that it is possible to discriminate between light originating directly or indirectly from a captured material or that originating from some spurious signal within a bulk layer, based on an angular orientation of the detector relative to the tagged material. The present invention however also provides for a modification of the substrate to which the tagged material is optically coupled so as to enable the specific out-coupling of light radiated into the substrate at angles greater than the threshold angle to a suitably positioned detector.

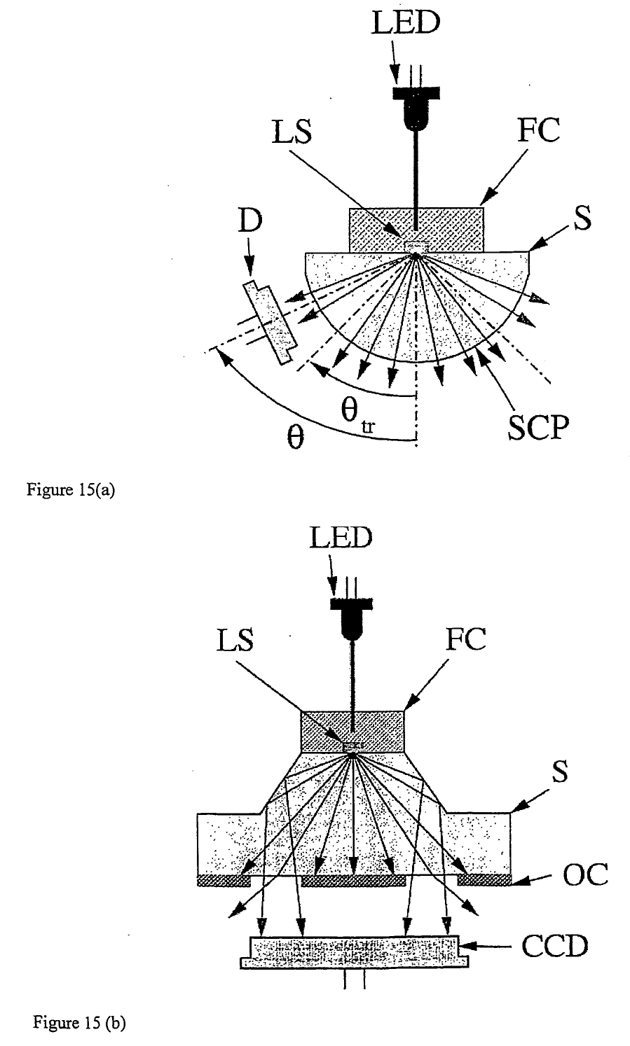

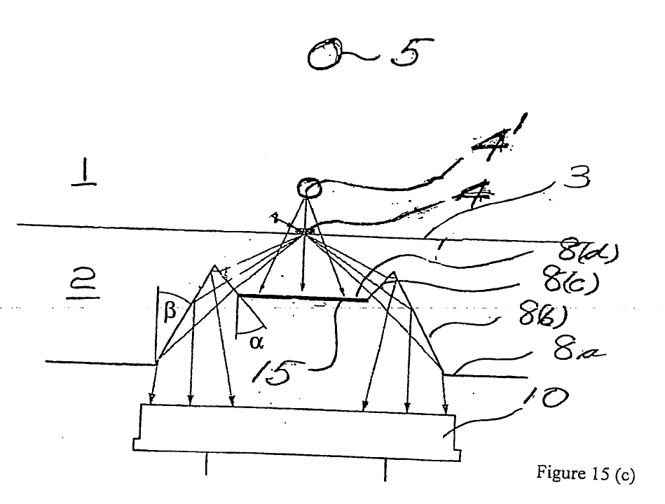

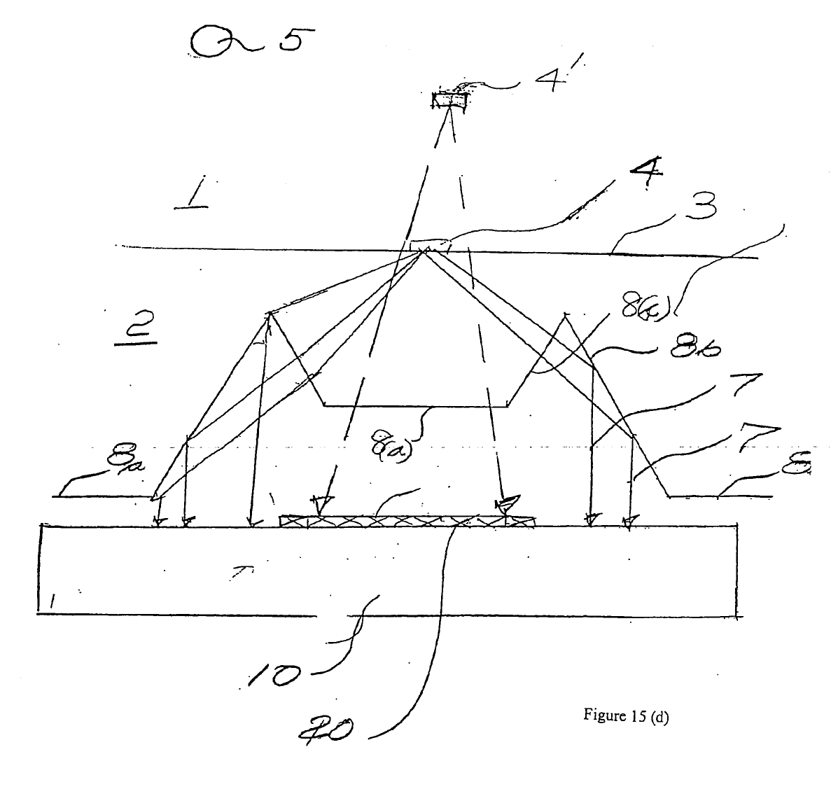

FIGS. 15a to 15d illustrate exemplary embodiments of the present invention and show how a sensor configuration can be arranged so as to specifically outcouple the light of interest.

In the embodiment of FIG. 15(a), the substrate (S), above which the luminescent solution can flow within a flow cell (FC), is attached to a semi-cylindrical prism (SCP) made from the same material as the substrate, for example glass. A luminescent sample (LS) is illuminated using a direct source of illumination such as a LED, and the resultant light propagating in the substrate above the threshold angle can be detected by a detector positioned at angles greater than the threshold angle. The detector is suitably a CCD camera, a linear detector array or some equivalent.

The embodiment of FIG. 15(b) employs an alternative configuration utilising opaque coatings (OC), providing the substrate in the form of a frusto-conical configuration. The surface generated luminescence is transmitted to an area at the detector, which is spatially seperated from the area where the luminescence originating from the bulk layer is transmitted. This bulk layer contribution is occluded by providing opaque coatings which prevent the corresponding light from being detected or, again, by processing of the image obtained by the CCD chip, which acts as the detector.

FIG. 15(c) illustrates a construction of substrate, identified by the reference numeral 2, which is configured so as to provide such a selective out-coupling. In this embodiment, there is a lower configured surface 8, various parts of which are identified by the reference numerals 8(a), 8(b), 8(c) and 8(d). On the surface 8(d). On the surface 8(d), there is provided a light barrier 15 provided by an opaque surface formed on the lower surface 8(d) of the substrate 2. Thus, the luminescence generated in the superstrate 1 by the light source 5 exciting a luminescence source 4′ in the superstrate 1 which is further away than some application specific distance tₛ (e.g. tₛ=2 λ) (i.e. in the second layer) from the surface 3, will be absorbed by the opaque surface 8(d). However, the surface generated luminescence, that is to say, the luminescence generated by the light source 5 exciting the luminescent source 4 placed closer to the surfaces 8(c) and 8(b) and in the first layer, will be, by refraction and reflection, redirected to the detector 10. The light is first refracted through the surface 8(c) and then reflected downwards from the surface 8(b) towards the detector.

Referring now to FIG. 15(d), there is illustrated an alternative construction of assembly, in which parts similar to those described with reference to FIG. 15 are identified by the same reference numerals. In this embodiment, instead of placing any barrier on the substrate 2, the barrier is placed on the detector 10 and comprises a blocking plate 20 which, as can be seen, will block the luminescent light coming from the excitation of luminescent sources in the volume of the superstrate such as the luminescent source 4′.

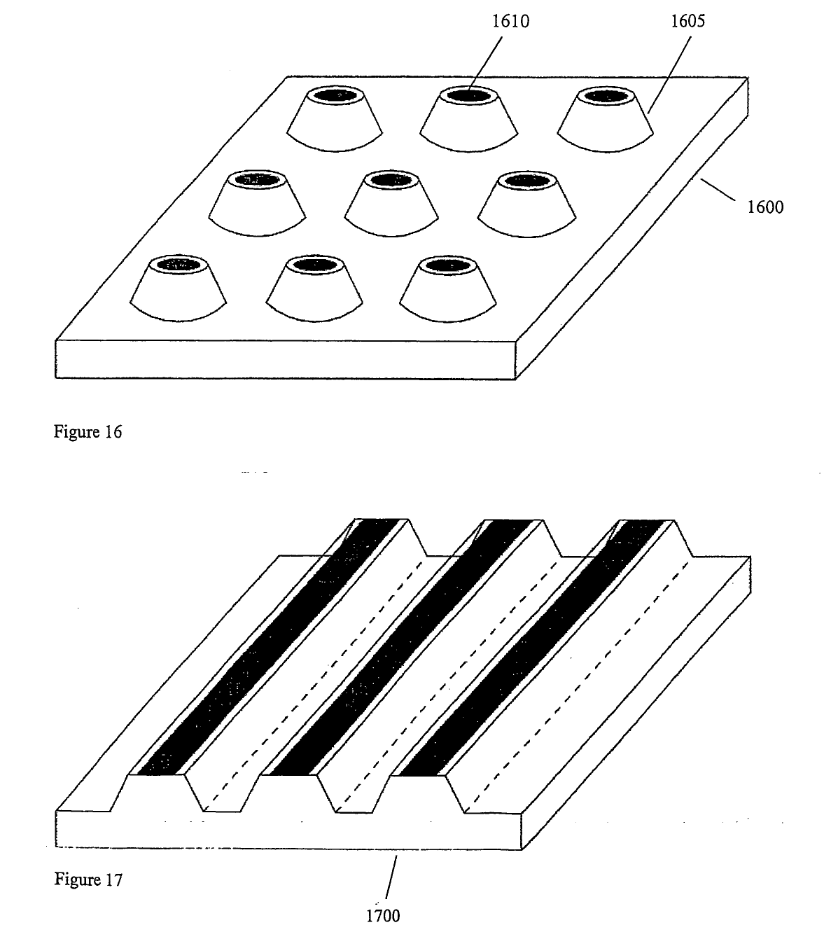

FIGS. 16 and 17 are schematic diagrams of sensor chips 1600, 1700 incorporating a plurality of individual sensor configurations according to embodiments of the present invention. In FIG. 16, a plurality of frusto-conical structures 1605, similar to that described in FIG. 15b are deployed in an array. These frustrated cones each have a luminescent spot 1610 deposited on the upper surface thereof, and by suitably positioning a detector arrangement, the light emitting from each spot can be spatially distinguished. FIG. 17 shows an alternative embodiment employing a groove or ridge like pattern.

Accordingly it will be appreciated that the present invention provides a technique for the collection of surface generated luminescence excited by direct illumination. The ability to discriminate by origin of the luminescence enables the use of such direct illumination, which is advantageous in that the sensitivity of sensor arrays utilising such techniques can be increased due to higher levels of illumination than hereintobefore possible.

In the specification the terms “comprise, comprises, comprised and comprising” or any variation thereof and the terms “include, includes, included and including” or any variation thereof are considered to be totally interchangeable and they should all be afforded the widest possible interpretation.

It will be further appreciated that the invention is not limited to the embodiments hereinbefore described but may be varied in both construction and detail. Furthermore, although certain embodiments may have been described with reference to specific integers or components it will be appreciated that individual components from different embodiments may be interchangeable depending on the desire of the user without departing from the scope of the present invention. It will nₑ further appreciated that although the present invention has been described with reference to specific substrate or medium (fluid) types, that it is not intended to limit the present invention to these specific exemplary embodiments of the invention.

1. A luminescent sensor configuration for use in a medium having a first refractive index, the sensor configuration comprising:
a) a source of direct illumination,
b) a substrate having an upper and lower surface and being of a second refractive index,
c) a material capable of luminescence,
d) a detector arrangement provided below the lower surface of the substrate and adapted to detect light emitted through that lower surface,
e) a barrier adapted to block light which has been transmitted into the substrate at an angle below a critical angle,
f) at least one optical redirection element at either an upper or lower surfaces of the substrate, the optical redirection element adapted to redirect light emitted by the luminescent material into the substrate at an angle greater than the critical angle out of the substrate and towards a detector
and wherein, in use, the medium and the substrate meet along the upper surface of the substrate which defines the boundary between the first and second refractive indices, the material capable of luminescence is excited by the source of direct illumination, thereby luminescing and the detector arrangement is adapted to discriminate between luminescent light emitted from a first layer within a predetermined distance of the upper surface and light emitted from a second separate layer, the discrimination being effected by selective detection of light emitted from the luminescent material at angles greater than a critical angle of the medium/substrate interface.

2. The configuration as claimed in claim 1 wherein the predefined distance is less than about 4 λ, and preferably within the range of about 0.5 λ to about 3 λ, wherein λ is the wavelength of the luminescence light.

3. The configuration as claimed in claim 2 wherein the predefined distance is within the range of about 1 to about 2 λ.

4. The configuration as claimed in claim 1 wherein the angle at which the luminescence is emitted into the substrate and subsequently selectively detected is greater than a threshold angle, the threshold angle being an angle which satisfies the equation:
Iₛ(Θₜᵣ)/I_{b}(Θₜᵣ)=Fₜᵣ,
where Iₛ(Θₜᵣ) is the intensity of light emitted from the first layer at the threshold angle, I_{b}(Θₜᵣ) is the intensity of light emitted by the second layer at the threshold angle and Fₜᵣ is a performance factor which is selected by the user.

5. The configuration as claimed in claim 4 where I_{b}(Θₜᵣ) corresponds to a background level within the configuration such that an inequality reduces to providing a threshold angle which satisfies the inequality that the signal-to-background ratio of the measurement of the luminescence originating from the first layer is greater than some specified value Fₜᵣ.

6. The configuration as claimed in claim 1 wherein the first and second layers have the same refractive index.

7. The configuration as claimed in claim 1 wherein the first and second layers have different refractive indices.

8. The configuration as claimed in claim 1 wherein the light emitted into the substrate is emitted from more than one source and the detector arrangement is adapted to spatially discriminate between the respective origins of the detected light.

9. The configuration as claimed in claim 1 further comprising at least one portion of material adapted to capture a specific target species, the at least one portion of material being coupled to the substrate and adapted, in use, to capture any of a predefined target substance within the medium, the capture effecting the formation of a captured species, which either directly or indirectly is adapted to luminescence upon excitation, such luminescence being detectable by the detector.

10. The configuration as claimed in claim 9 comprising at least two distinct portions of material, each portion being coupled to the substrate and wherein the substrate is configured to redirect light emitted by each portion towards the detector such that the light received at the detector from a first portion is spatially independent from the light received at the detector from a second portion.

11. The configuration as claimed in claim 1 wherein the light detected by the detector is not totally internally reflected within the substrate prior to detection.

12. The configuration as claimed in claim 1 wherein the at least one optical redirection element is adapted to redirect the light using total internal reflection.

13. The sensor configuration as claimed in claim 1 comprising a plurality of optical redirection elements, each element comprising a frusto-conical structure raised above the upper surface of the substrate, each frusto-conical structure having side walls and an upper surface, luminescent material being carried on the upper surface of the structure, and wherein light emitted by the material into the structure is internally reflected by the side walls of the structure and directed towards a detector positioned beneath the substrate.

14. The sensor configuration as claimed in claim 1 comprising a plurality of optical redirection elements, each element comprising a ridge raised above the upper surface of the substrate and extending along the upper surface of the substrate, the ridge having side walls and an upper surface, luminescent material being carried on the upper surface of the ridge, and wherein light emitted by the material into the ridge is internally reflected by the side walls of the ridge and directed towards a detector positioned beneath the substrate.

15. The sensor configuration as claimed in claim 1 wherein the at least one optical redirection element is adapted to redirect the light using refraction.

16. The sensor configuration as claimed in claim 15 wherein the at least one optical redirection element comprises a prism optically coupled to a lower surface of the substrate, the prism being adapted to receive light incident on the lower surface of the substrate and redirect that light sideward towards a corresponding detector.

17. The sensor configuration as claimed in claim 16 comprising a plurality of prisms each prism being associated with a unique spot on the upper surface of the substrate, such that light emitted by a spot is received within its associated prism and re-directed towards a respective detector.

18. The sensor configuration as claimed in claim 16 wherein the prism is optically coupled to the lower surface of the substrate and the prism has at least the same refractive index as the substrate to which it is optically coupled.

19. The sensor configuration as claimed in claim 1 wherein the at least one optical redirection element is adapted to redirect the light using diffraction.

20. The sensor configuration as claimed in claim 19 wherein the optical redirection element comprises a diffractive optical element provided at the lower surface of the substrate.

21. The sensor configuration as claimed in claim 1 wherein the lower surface of the substrate is structurally configured to both reflect and refract light radiated into the substrate, the reflection and refraction of the light effecting a redirection of light towards a detector, the light redirected being that light propagating into the substrate at an angle greater than the critical angle of the substrate/medium interface.

22. The sensor configuration as claimed in claim 21 wherein the structural configuration of the lower surface is such as to provide a first surface on which light emitted from the material and incident thereon is refracted out of the substrate and towards the second surface, which reflects the light which is incident thereon towards the detector.

23. The sensor configuration as claimed in claim 1 wherein the selective detection of light is effected by providing the substrate with non-parallel upper and lower surfaces, the angle of the upper and lower surfaces being such that the light emitted by the luminescent material is incident on the surfaces at angles greater than the critical angle of the substrate/medium interface, thereby effecting a propagation of light along an axis of the substrate towards a detector.

24. The sensor configuration as claimed in claim 1 being further adapted to detect light radiated into the substrate by material in the first layer at angles which are not less than a critical angle of the material/substrate interface and greater than the critical angle of the medium/substrate interface.

25. The sensor configuration as claimed in claim 1 wherein the detector is one of a CMOS, a CCD and a photodiode type detector.

26. A sensor configuration as claimed in claim 1 wherein the material capable of luminescence is sensitive to an analyte with which the sensor is intended to be used, such that the presence of an analyte in the medium with which the sensor is used, and the subsequent illumination of the configuration, effects a luminescence of the material, said luminescence being detectable at the detector.

27. A sensor configuration as claimed in claim 1 wherein the sensor is provided initially with a bio-recognition element, the bio-recognition element being sensitive to and adapted to couple with any predefined target biological sample in the medium with which the sensor is used, and once coupled, a further coupling of the coupled biological sample/bio-recognition element with a luminescent tag effects the formation of the luminescent material.

28. A sensor configuration as claimed in claim 1 wherein the barrier is provided in or on the substrate.

29. A sensor configuration as claimed in claim 1 wherein the barrier is provided on the detector.

30. A luminescence sensor comprising:
a) a substrate having an upper and lower surface and adapted to receive incident light emitted from a luminescence material optically coupled to the upper surface thereof,
b) a detector adapted to detect the light emitted into the substrate and out of the lower surface of the substrate
c) a source of direct illumination for effecting direct illumination of the luminescence material
d) at least one optical redirection element at either an upper or lower surfaces of the substrate, the optical redirection element adapted to redirect light emitted by the luminescent material into the substrate at an angle greater than the critical angle out of the substrate and towards a detector
e) a barrier adapted to block light which has been transmitted into the substrate at an angle below the critical angle,
f) at least one optical redirection element at either an upper or lower surfaces of the substrate, the optical redirection element adapted to redirect light emitted by the luminescent material into the substrate at an angle greater than the critical angle out of the substrate and towards a detector, and
wherein the substrate is specifically adapted to outwardly direct light defined by light propagating within the substrate at angles greater than a critical angle of the substrate/material interface from the substrate and towards the detector.

31. An assay platform for use in detecting the presence of a substance in a medium, the platform comprising a substrate having at least one optical redirection element at either upper or lower surfaces of the substrate, the optical redirection element adapted to specifically redirect light radiated into the substrate by a luminescent material at angles which are greater than a critical angle of the medium/substrate interface, the light being redirected out of the substrate and towards a detector provided below the lower surface of the substrate, the luminescence being effected by direct illumination of the luminescent material.

32. A method of discriminating between luminescent light emitted from a luminescent material provided in a first layer above a substrate and light emitted from a second layer above the substrate, the method comprising the steps of:
a) illuminating the first and second layers with a source of direct illumination,
b) providing a detector arrangement below the substrate,
c) arranging the detector and/or substrate so as to selectively discriminate between the sources of light detected, the discrimination being effected based on the angles at which the light propagates into the substrate, such that light emitted from the first layer only is detected at the detector,
d) optically redirecting, at either an upper surface or lower surfaces of the substrate, light emitted by the luminescent material into the substrate at an angle greater than the critical angle out of the substrate and towards a detector,
e) blocking light which has been transmitted into the substrate at an angle below the critical angle, and
f) providing a barrier adapted to block light which has been transmitted into the substrate at an angle below the critical angle.

33. The method as claimed in claim 32 wherein the angle is greater than the critical angle of the second layer/substrate interface.

34. The method as claimed in claim 32 wherein the angle is greater than a threshold angle, the threshold angle being that angle which satisfies the equation:
Iₛ(Θₜᵣ)/I_{b}(Θₜᵣ)=Fₜᵣ,
where Iₛ(Θₜᵣ) is the intensity of light emitted from the first layer at the threshold angle, I_{b}(Θₜᵣ) is the intensity of light emitted by the second layer at the threshold angle and Fₜᵣ is a performance factor which is selected by the user.

35. The configuration as claimed in claim 34 wherein I_{b}(Θₜᵣ) corresponds to a background level within the configuration system such that an inequality reduces to providing a threshold angle which satisfies the inequality that the signal-to-background ratio of the measurement of the luminescence originating from the first layer is greater than some specified value Fₜᵣ.

36. An assay platform for use in detecting the presence of a substance in a medium, the platform comprising a substrate having a taggable material coupled thereto, the taggable material being adapted to couple with the substance thereby forming a source of luminescence, the luminescence being effected upon direct illumination of the tagged material, and wherein the tool is further configured such that light emitted from the tagged material at angles greater than a critical angle of the medium/substrate interface is detected.
